(19) United States
(12) Patent Application Publication
(10) Pub. No.: US 2006/0059109 A1
(43) Pub. Date: Mar. 16, 2006

(54) Password protected keyless entry

(76) Inventor: Ronald Paul Grimes, Manassas, VA (US)

Correspondence Address: RONALD P. GRIMES, P.O. BOX 684, FLORISSANT, CO, 80816, US

(21) Appl. No.: 10/682,145

(22) Filed: Sep. 14, 2004

(51) Int. Cl. G06Q 99/00

(52) U.S. Cl. 705/72

(57) ABSTRACT

This invention is a combination of a vehicle's control computer and either a cell phone or WIFI transceiver with the vehicle identification number (VIN) and a password programmed into the control computer. The password is selected by the vehicle's owner and would allow remote access to the vehicle, to open the doors in case the keys were accidentally locked inside, and to disable the vehicle in case of theft simply by changing the password or by accessing other possible functions as described in the specification.

The combining of either a cell phone or WIFI transceiver with a vehicle's engine or master control computer allows remote access to the vehicles computer. The vehicle computer would have the vehicle identification number (VIN) programmed into it and a password (selected by the vehicle owner) is also programmed, either at the time of purchase or at any date the vehicle is upgraded to this system or the vehicle is sold to a new owner.

After implementation of this system, the vehicle owner would be able to access the vehicle remotely in order to;
1. Unlock the doors in case the keys were unintentionally locked inside
2. Disable the vehicle in case of theft
3. Start the vehicle
4. Set the climate control
5. Transmit to enable locating the vehicle
6. Other options desired by the owner
7. Change the password I

n the case of a cell phone, when the cell phone number is dialed the vehicle computer would respond with a request for the password, once the password is recognized by the vehicle's computer, it would respond with a list of options, much like the options offered by voicemail on current cell phone accounts as listed above.

In the case of a WIFI transceiver, a WIFI signal is sent with the vehicle's VIN and the vehicle responds with a request for the password. The WIFI option would be the best of the 2 implementations discussed here because there would not be a carrier charge, and if the owner happens to own a bluetooth enabled phone, the phone would be able to recognized the vehicle and form a partnership with it.

A bluetooth capable WIFI transceiver combined with the vehicle control computer would be the best possible solution if cost of ownership were a consideration, however if the owner decides to have a built in cell phone in the vehicle it would be a better option to simply install that.

The main objective is that the owners are allowed access to their vehicle and nobody else could gain access. The vehicle manufacturer would also need to have a secure password for each VIN in case of forgotten passwords or vehicles sold to another party

This invention can be both an option offered on new cars and an add-on sold as a modification. The only requirement is that the vehicle has Cruise Control.

The vehicle's cruise control outputs are connected to the “Automatic Cruise Control” unit, which contains either a GPS receiver or a cell/WIFI transceiver which tracks the vehicle position and an internal database or a central database containing the local speed limits for the current location updates the cruise control settings. The vehicle driver still is able to use the existing increase/decrease controls to change the vehicle speed as preferred, and an option to disable the unit allows monitoring of local speed limits and displays them with audible warnings if desired.

If the unit has an internal database, it can be updated whenever desired by downloading from a web site that is updated daily, and if it has an active database the unit updates itself within a radius selectable by the owner using wireless networks within range.

If properly used the vehicle owner would never be subjected to speeding tickets, and if every vehicle were so equipped, it could alleviate traffic jam problems across the country.

1. I claim that it is my invention to combine a VIN (vehicle identification number) with a password chosen by the owner at the time of purchase in order to afford the vehicles owner complete security over its use.
